(19) United States
(12) Patent Application Publication
(10) Pub. No.: US 2025/0231014 A1
(43) Pub. Date: Jul. 17, 2025

(54) Tape Hooker

(71) Applicant: Jeffrey Andrew Clark, Trussville, AL (US)

(72) Inventor: Jeffrey Andrew Clark, Trussville, AL (US)

(21) Appl. No.: 18/412,839

(22) Filed: Jan. 15, 2024

(51) Int. Cl. G01B 3/1048

(52) U.S. Cl. CPC G01B 3/1048

(57) ABSTRACT

The present invention discloses a compact tape measure, comprising a hook, housing case, reels handle in which the casing is designed to snap the hook in. The hook is fixed at the end of the tape measure with longer edges to hook onto items that a regular tape measure. The hook attached to the casing when not in use. The hook is located at the base of the measuring tape in a case, wherein the hook is attached to the housing case by precision shoulder screw and socket screw. The reel's handle with a handle pivot base and attached to the handle, thumb screw twist, flange lockout and shoulder screw. The tape and handle have other features like blind pivot, socket head screw and blade type of plastic fiber glass blade. Also disclosed is a method of making the same for appraisers and real estate industry.

### TECHNICAL FIELD

The present invention relates to measuring tapes, and more specifically to a tape hooker or compact tape measure with a hook and method of making the same for appraisers and anyone in the real estate industry.

### BACKGROUND ART

Tape measure is used to grab onto the end of a nail or screw. This way, if you're measuring a flat surface and don't have anyone to hold the other end of the tape, you just need to hammer in a nail or insert a screw and hook the end of the tape onto it to get a clear and accurate measurement. The hook itself has a thickness of exactly 1/16″, and wouldn't you know it, the hook actually has exactly 1/16″ worth of movement. When you use a tape, this maintains precision by accounting for the width of the hook from both the inside edge and outside edge of whatever you measure

Additionally, measuring tapes can be cumbersome to use in certain situations, particularly when measuring long distances or in tight spaces. The main disadvantages include marginal or poor inside measurements, poor measurements under one inch, too wide to measure many depths (bored holes/cuts under ¾″D). The other disadvantages of using this are the tape will sag and the tape might not be horizontal because the person downhill may be holding it too low or too high. In addition, the temperature can affect the length of the tape. This method is also too labor intensive for the surveyors.

Tape measure is a commonly used measuring tool in daily life. It can be divided into fiber tape measure, cloth tape measure and steel tape measure according to different materials. Most common tape measure is steel ruler or cloth ruler. Everyone often sees steel tape measure, construction and Decoration is commonly used and is one of the must-have tools for families.

The Chinese-based international patent application that was published as WO2019024133A1 in 2019 discloses a digital measuring tape comprises a housing (10), a measuring blade (20), and a measuring blade casing (30). A reel (11) is provided inside the housing (10). The measuring blade casing (30) is rotatably mounted on the reel (11). The measuring blade (20) is wound around the measuring blade casing (30). A hook (21) is provided at a front end of the measuring blade (20). The digital measuring tape further comprises a marked disc (40), mark detectors (50, 200, 300), a circuit board (60), and a display screen (70). The marked disc (40) is rotatably fixed on the measuring blade casing (30). Marks (41) are provided on the circumference of the marked disc (40). Rotation of the marked disc (40) and the marks (41) causes the mark detectors (50, 200, 300) to generate a detection signal for the rotation of the marked disc (40), and a length of the exposed measuring blade (20) is calculated by the circuit board (60) on the basis of the detection signal, and displayed on the display screen (70). The digital measuring tape performs accurate measurement in scenarios requiring highly precise measurements, and the measurements provided are convenient to read.

The U.S. Pat. No. 8,898,922B2 of 2012 describes a tape measure with finger drag brake. A tape measure with a finger recess in a housing, with at least a portion of the underside of a tape blade exposed in the finger recess. Pressing a finger against the underside of the tape allows the user to create a drag brake that acts against the retraction spring to slow and/or stop the retraction of the tape blade. The finger recess is located upstream (i.e. closer to the coiled portion of the retracted tape blade) than the point at which the tape measure's lock engages the tape blade. This arrangement results in a compact yet versatile overall tape measure with good tactile feedback during finger-braking.

However, the above prior art disclosures are different from the proposed invention.

A typical tape measure has a small end hook that is hard to hook onto walls, gutters, brick, siding etc. This is a common complaint with real estate appraisers who are required to measure homes via standards. The typical tape measure hook is hard to measure long distance (houses) without falling off the wall etc. Tape Hook is designed as a compact tape measure with a HOOK that will measure long distances with ease. This tape measure is not just for appraisers but anyone in the real estate industry and anyone sick of the traditional tape measure.

Therefore, there is need to develop a user-friendly a compact tape measure with a hook to be used in appraisals, real estates, realtors, landscaping, project management, contractors, home repair, general uses.

### OBJECTS OF THE INVENTION

The main object of the present invention is to provide a compact tape measure with a hook for appraisers and in the real estate industry.

The following summary is an explanation of some of the general inventive steps for the system, method, architecture and container in the description. This summary is not an extensive overview of the invention and does not intend to limit the scope beyond what is described and claimed as a summary.

### SUMMARY OF THE INVENTION

The present invention describes a measuring tape. The invention presents a tape hooker or compact tape measure with a hook and method of making the same for appraisers and anyone in the real estate industry.

The typical tape measure hook is hard to measure long distance (houses) without falling off the wall etc. The present tape hook is designed as a compact tape measure with a hook that will measure long distances with ease. The said tape measure is designed for appraisers and anyone in the real estate industry.

A compact tape measure made for the design of a hook that will attach to gutters, side of houses, walls, fencing stick in the ground etc. The hook is long enough that will hold.

The preceding summary is intended to serve as an introduction to some embodiments of the invention. It is not meant to be an overview of all inventive subject matter disclosed in this specification. The detailed description that follows and the drawings that are referred to in the detailed description will further describe the embodiments described in the summary as well as other embodiments. Accordingly, to understand all the embodiments described by this document, a full review of the summary, detailed description and drawings is needed.

### BRIEF DESCRIPTION OF THE DRAWING

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 shows a representation of a measuring tape with hook as described in the present invention.

FIG. 2 shows a representation of a compact tape measure with a hook as described in the present invention.

FIG. 3 shows a representation of a tape hook as described in the present invention.

FIG. 4 shows a representation of a reel's handle of the tape hook as described in the present invention.

FIG. 5 shows a representation of a reel's handle of the tape hook as described in the present invention.

FIG. 6 shows a representation of a tape and hook as described in the present invention.

FIG. 7 shows a representation of a tape and hook as described in the present invention.

FIG. 8 shows a representation of a casing of the tape hook as described in the present invention.

FIG. 9 shows a representation of a casing of the tape hook as described in the present invention.

FIG. 10 shows a representation of a casing of the tape hook as described in the present invention.

### DESCRIPTION OF THE INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

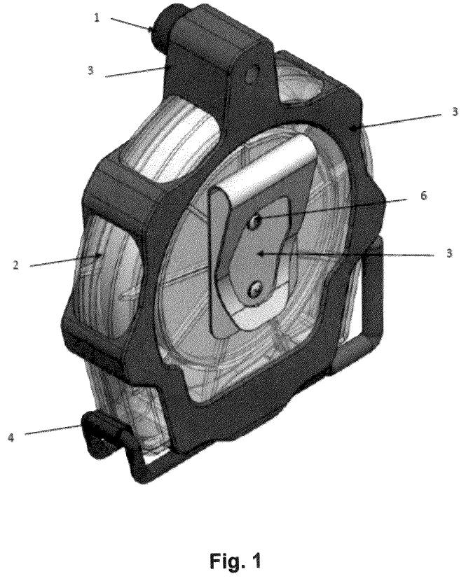

The present invention describes a compact tape measure with a handle 1 and hook 4 for appraisers and in the real estate industry. The tape hook, comprises a measuring tape 2, housing case 3, reels handle 1 and precision screw according to FIGS. 1-10.

A tape measure 2 including a housing arranged to enclose an internal cavity, where the housing 3 defines a front wall. A port is formed in the housing and spaced a non-zero distance from the front wall. A measuring tape is at least partially disposed within the internal cavity of the housing and extends through the port. The measuring tape 2 is rotatably coupled to the housing with a hook 4. A finger guard assembly is positioned adjacent the front wall, such that the finger guard assembly cooperates with the port to define a space there between. The measuring tape 2 passes through the space outside of the housing to facilitate the control of the retraction and extension of the measuring tape through contact within the space.

The hook and casing to snap the hook in. The unique items include the hook at the end of the tape measure 2 with longer edges to hook 4 onto items that a regular tape measure 2 would not or have a hard time doing so. Also, the casing that the hook 4 attached to when not in use in unique. The tape measure 2 is also a compact design.

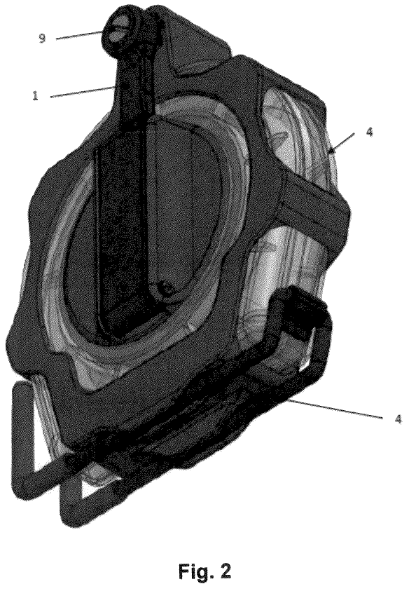

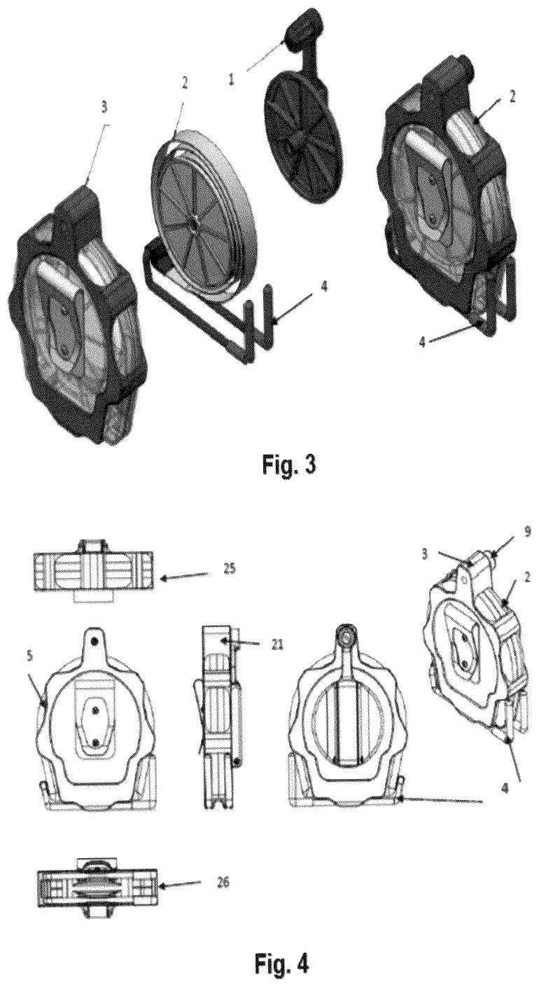

In FIG. 1, the invention shows a representation of a tape hook 4 at the base of the measuring tape 2 in a case 3 further comprising a hook 4. In FIG. 2, the invention shows a representation of a compact tape measure 2 with a hook 4 attached to the housing case 3 by precision shoulder screw 9 and socket screw 14 as described in the present invention. In FIG. 3, the invention shows a representation of a measuring tape 2 with a hook 4 attached to the casing 3. It also presents a reel's handle 5 and handle pivot base 6. In FIG. 4, the invention shows a representation of a reel's handle 5 attached to the handle 1, handle pivot base 6, thumb screw twist 5 detached from the compact tape measure 2 with a hook 4. The invention further shows a flange lockout 8 and the shoulder screw 7 as described in the present invention.

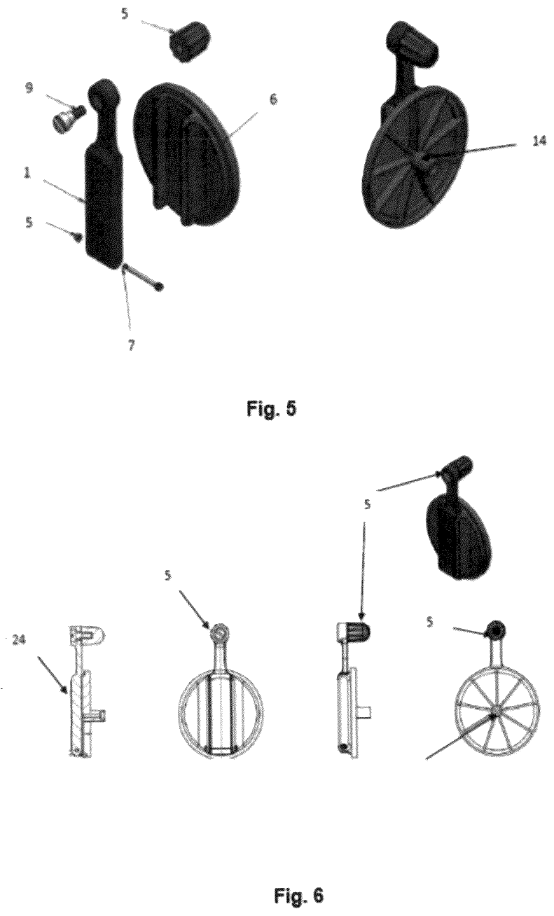

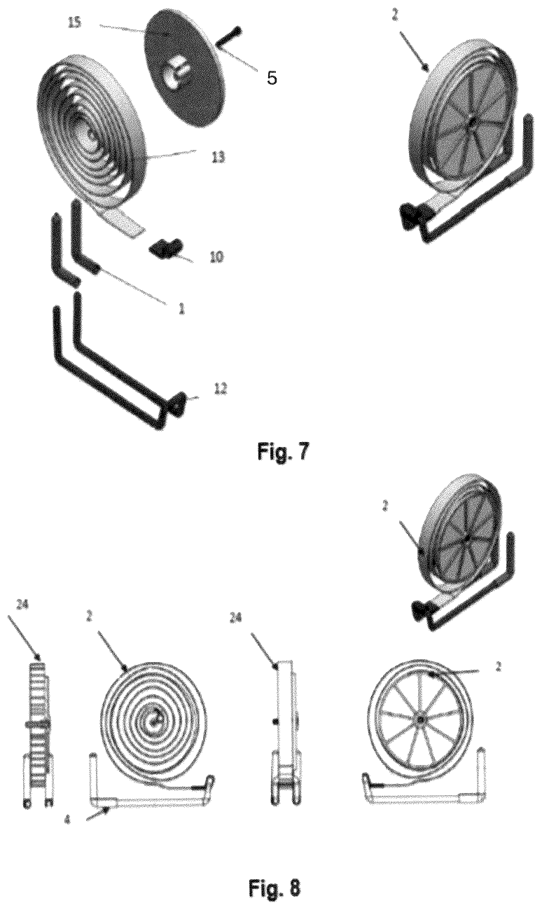

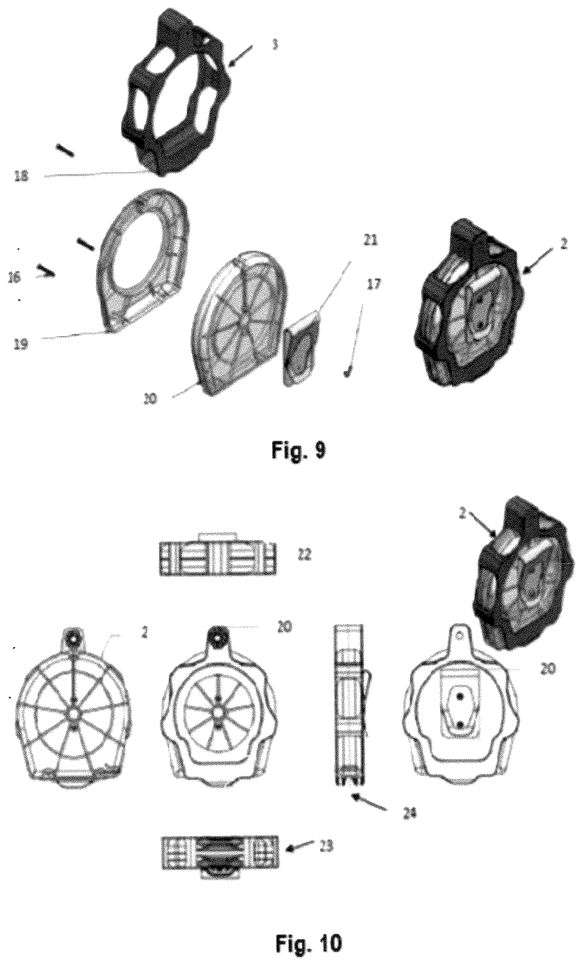

In FIG. 5, the invention shows a representation of a reel's handle 5 sub-assembly of the compact tape measure 2 with a hook 4 fixed by the flange lockout device 8 as described in the present invention. In FIG. 6, the invention shows a representation of a compact tape measure 2 with a hook 1 and other features like blind pivot 15, socket head screw 14 and blade type 13 of plastic fiber glass blade. The hook's silicon cover 11, blade's hook attachments 10 made of malleable material are detached from the main assembly to show the appraisal's hook 12 as described in the present invention. In FIG. 7, the invention shows a representation of a compact tape measure 2 with a hook 4 and as described in the present invention. In FIG. 8 and FIG. 9, the invention shows a representation of a casing 3 of the compact tape measure 2 presenting Phillip's flat head screw 16, thread forming screws 17, silicone overall 18, left cover 19, right cover 20 and belt clip 21 as described in the present invention.

In FIG. 10, the invention shows a representation of a casing 3 of the compact tape measure 2 presenting a precision shoulder crew 9 on the reel′ handle 5, bottom vie 23 of casing 3, side view of the casing 24, tape 2 and top view 22 of the casing 3 as described in the present invention.

Further, in another embodiment the invention presents a compact tape measure 2 comprising a housing case 3 arranged to enclose an internal cavity, the housing defining a front wall; a handle 1 formed on the housing assembly and spaced a non-zero distance from the front wall; a measuring tape 2 at least partially disposed within the internal cavity of the casing 3 and extending between the hook 4, the measuring tape rotatably coupled to the housing 3; and a hook 4 assembly positioned adjacent the front wall, the hook guard assembly 4 cooperating with the screws to define a space there between, the measuring tape passing through the space outside of the housing to facilitate the control of the retraction and extension of the measuring tape 2 through contact within the space.

In addition, the hook member 4 disposed on a free end of the measuring tape 2, the hook member 4 engaging the handle 1 guard assembly to prevent retraction of the hook member 4 into the space.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations.

Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

### INDUSTRIAL APPLICATION

The present invention applies to measuring tapes in the real estates. It avails a tape hook or compact tape measure with a hook. It also offers a novel method of making the same for appraisers and anyone in the real estate industry.

What is claimed is:

1. A compact tape measure, comprising:
a hook,
a housing case, and
a handle.

2. The compact tape measure according to claim 1, wherein the hook and casing to snap the hook in.

3. The compact tape measure according to claim 1, wherein the hook is fixed at the end of the tape measure.

4. The compact tape measure according to claim 3, wherein the tape has longer edges to hook onto items that a regular tape measure would not or have a hard time doing so.

5. The compact tape measure according to claim 1, wherein the house casing is designed to provide means on the hook is attached to when not in use.

6. The compact tape measure according to claim 4, wherein the tape measure is compact in design.

7. A compact tape measure, comprising:
a hook at the base of the measuring tape;
a casing house, and
a reel's handle.

8. The compact tape measure according to claim 7, wherein the hook is located at the base of the measuring tape in a case, wherein the hook is attached to the housing case by precision shoulder screw and socket screw.

9. The compact tape measure according to claim 7, wherein the reel's handle with a handle pivot base and attached to the handle, thumb screw twist, flange lockout and shoulder screw.

10. The compact tape measure according to claim 7, wherein the tape and handle have other features like blind pivot, socket head screw and blade type of plastic fiber glass blade, and further comprising a hook's silicon cover, blade's hook attachments made of malleable material are detached from the main assembly to show the appraisal's hook.

11. The compact tape measure according to claim 7, wherein the casing of the compact tape measure presents Phillip's flat head screw, thread forming screws, silicone overall, left cover, right cover and belt clip.

12. A compact tape measure comprising:
a housing arranged to enclose an internal cavity, the housing defining a front wall;
a handle formed on the housing assembly and spaced a non-zero distance from the front wall;
a measuring tape at least partially disposed within the internal cavity of the casing and extending between the hook, the measuring tape rotatably coupled to the housing; and
a hook assembly positioned adjacent the front wall, the hook guard assembly cooperating with the screws to define a space there between, the measuring tape passing through the space outside of the housing to facilitate the control of the retraction and extension of the measuring tape through contact within the space.

13. The compact tape measure according to claim 12, wherein the tape measure further comprising a hook member disposed on a free end of the measuring tape, the hook member engaging the handle guard assembly to prevent retraction of the hook member into the space.
